(19) United States
(12) Patent Application Publication
(10) Pub. No.: US 2005/0108682 A1
(43) Pub. Date: May 19, 2005

(54) Systems for type-independent source code editing

(75) Inventors: Britton Worth Piehler, Seattle, WA (US); Kevin Zatloukal, Cambridge, MA (US); David Glen Garber, Bellevue, WA (US)

Correspondence Address: FLIESLER MEYER, LLP, FOUR EMBARCADERO CENTER, SUITE 400, SAN FRANCISCO, CA, 94111, US

(73) Assignee: BEA Systems, Inc., San Jose, CA (US)

(21) Appl. No.: 10/785,564

(22) Filed: Feb. 24, 2004

Related U.S. Application Data
(60) Provisional application No. 60/449,984, filed on Feb. 26, 2003.

(51) Int. Cl. G06F 9/44

(52) U.S. Cl. 717/110; 717/140

(57) ABSTRACT

An extensible, data-driven, language independent source code editor is presented, with an embedded, extensible multi-language compiler framework. Such an editor can be tightly integrated with a compiler framework that provides detailed information about the language currently being edited by the user. This information can be provided in a language-neutral way effectively decoupling the editor from the underlying set of languages being edited. In addition, a language-independent editor can expose a set of APIs that makes it easy to customize behavior for specific languages that have characteristics not shared by most languages. This set of APIs can also enable the development of customized views, such as for developing visual editors that represent and allow the user to manipulate aspects of the source code pictorially. This description is not intended to be a complete description of, or limit the scope of, the invention. Other features, aspects, and objects of the invention can be obtained from a review of the specification, the figures, and the claims.

### CLAIM TO PRIORITY

The present application claims the benefit of priority under 35 U.S.C. §119(e) to U.S. Provisional Patent Application entitled “SYSTEMS AND METHODS FOR TYPE INDEPENDENT SOURCE CODE EDITING”, application Ser. No. 60/449,984, filed on Feb. 26, 2003, which application is incorporated herein by reference.

### COPYRIGHT NOTICE

A portion of the disclosure of this patent document contains material which is subject to copyright protection. The copyright owner has no objection to the facsimile reproduction by anyone of the patent document of the patent disclosure, as it appears in the Patent and Trademark Office patent file or records, but otherwise reserves all copyright rights whatsoever.

### FIELD OF THE INVENTION

The present invention relates to the editing of software and software components.

### BACKGROUND

Modern “smart” source code editors provide a wide range of features to the software developer based on increased understanding of the underlying programming language. For example, these editors may provide syntax coloring to highlight various components of the language grammar (class definitions, fields, methods, comments, etc.) The editors may also highlight known errors in the code. In general, this increased understanding of the underlying programming language is achieved by adding a language specific lexical analyzer and/or parser to the editor.

Unfortunately, most large-scale development projects include several programming languages targeted at different domains and different classes of developers. For example, it is not uncommon for a modern web application to include Java, Java Server Pages (JSP), JavaScript, the Hypertext Markup Language (HTML) and the extensible Markup Language (XML). Therefore, a typical development environment may effectively include several “smart” source code editors, each with an embedded lexical analyzer and/or parser specific to a given language.

Developing and maintaining a separate editor for each language in the development environment is costly and time consuming. Each time a new language is needed, a new editor must be constructed. Each time a new editing feature is added, it must be added to each language module. In addition, keeping the features of the language editors in sync can be a challenge. Minor differences between the editors in a given development environment can result in an inconsistent and confusing experience for the developer.

In addition, it is becoming increasingly useful to embed one language inside another within a single source file. For example, JSP pages include Java and JSP tags embedded within HTML. Emerging languages, such as ECMAScript for XML(E4X) embed XML within JavaScript. Other emerging technologies, such as Java for Web Service (JWS) embed a small annotation language inside Java comments to succinctly describe how that Java class should be exposed as a web service. In some cases, several languages can be nested several layers deep in a single source file.

The simple lexical analyzers and parsers embedded in common source editors are usually not sophisticated enough to recognize and process nested languages. Therefore, in some environments advanced source code editing features are simply not available for nested languages.

In other environments, a new editor might be constructed specially tailored to handle each new language combination even if separate editors already exist for each of the nested languages. For example, a JSP editor might be constructed to handle the combination of HTML, JSP tags and Java, even though separate HTML and Java editors already exist in the development environment. A new E4X editor may be constructed even though separate ECMAScript and XML editors already exist. This may result in duplication of code and will likely result in inconsistent behaviors as the different language editors evolve.

As language nesting becomes more popular, the increase in cost and time required to develop and maintain a comprehensive suite of smart editors using traditional methods becomes combinatorial.

To make matters worse, some nested languages appear in several contexts. For example, XML may be embedded in ECMAScript, Java and JWS annotations. In addition, small expression languages such as those required to understand date and time formats (e.g., YYYY-MM-DDThh:mm:ssTZD from ISO 8601) or time durations (e.g., 15h4m30s) may be embedded in several different languages. Adding these common sub-languages separately to each editor's lexical analyzer and/or parser again results in increased development and maintenance costs and potentially inconsistent behaviors. Any changes to the way these common sub-expressions are handled should be applied uniformly across all applicable host languages.

In a typical Integrated Development Environment (IDE), there are often two compilers. The first compiler is run from the command line, displaying a list of errors or emitting runable code. The second compiler exists as part of the IDE. Initially, this compiler may only implement lexical analysis of source code in order to support syntax coloring. Then it may implement syntactic analysis in order to support the structure pane and class browser. Eventually, this compiler will contain a nearly complete front-end in order to support code completion.

The trend of moving more and more of the compiler into the IDE is understandable: advanced IDE features are often based on advanced understanding of the language being edited. Unfortunately, it is not normally possible to use the command-line compiler inside the IDE. First, it is normally not componentized in such a way that the information needed by the IDE is easily accessible. Second, it is usually far too slow for interactive use as changes are made, especially if it takes multiple passes over the files. Third, it almost always recovers poorly from errors, which amongst other problems, makes code completion impossible.

These issues force the IDE to create its own compiler. However, supporting two compilers has many disadvantages. First, it is nearly twice the work of implementing a single compiler, particularly where the back-end is a fairly high-level language (i.e. Java bytecodes) and no optimization is performed. Second, the IDE's compiler is typically the second class citizen, and as a result, it is usually of lesser quality. Few IDE's actually implement 100% of the analysis in the command line compiler. Furthermore, the IDE's compiler is often designed in an evolutionary manner as new features are needed, resulting in a poorly organized compiler. Third, two different code bases need to be updated in order to make changes to the language. This makes creating a new language a slow and painful process. These problems get worse as the platform is scaled in the number of languages it supports and in the number and sophistication of IDE features.

### SUMMARY

In one embodiment, a source editor capable of editing multiple languages and a compiler framework are configured to communicate with language independent data. In one embodiment, the editor works using compiler meta data that is language independent. Thus, when a new language is introduced into the environment for editing and/or compiling, separate instructions regarding how to integrate the language for compiling or editing are not required. For these and other reasons, the editor provides an edit rich experience without using language specific knowledge.

### BRIEF DESCRIPTION OF THE DRAWINGS

FIG. 1 is an illustration of an editor interface in accordance with one embodiment of the present invention.

FIG. 2 is an illustration of an editor interface in accordance with one embodiment of the present invention.

FIG. 3 is an illustration of an editor interface in accordance with one embodiment of the present invention.

### DETAILED DESCRIPTION

In one embodiment, a source editor capable of editing multiple languages and a compiler framework are configured to communicate with language independent data. In one embodiment, the editor works using compiler meta data that is language independent. Thus, when a new language is introduced into the environment for editing and/or compiling, separate instructions regarding how to integrate the language for compiling or editing are not required. For these and other reasons, the editor provides an edit rich experience without using language specific knowledge.

To be competitive, a modern IDE should support multiple languages and many sophisticated IDE features. In addition, it is also useful for a compiler to support mixing and nesting languages within the same source file. For example, in emerging language such as E4X, the IDE should display errors for mismatched start and end tags in embedded XML and it should perform auto-completion of XML tags embedded in the source code. These features should be available independent of the host language embedding XML. As another example, JWS annotations should be treated as a nested language and the IDE should support features such as syntax coloring and code completion when editing the annotations.

Systems and methods in accordance with embodiments of the present invention overcomes problems in existing editing systems by providing and/or utilizing an extensible, data-driven, language independent source code editor with an embedded, extensible multi-language compiler framework. This editor may not include a language specific lexical analyzer or parser. Instead, the editor can be tightly integrated with a compiler framework that provides detailed information about the language currently being edited by the user. This information can be provided in a language-neutral way effectively decoupling the editor from the underlying set of languages being edited.

In addition, a language-independent editor can expose a set of APIs that makes it easy to customize behavior for specific languages that have characteristics not shared by most languages. This set of APIs can also enable the development of customized views, such as for developing visual editors that represent and allow the user to manipulate aspects of the source code pictorially.

Multi-Language, Compiler Framework

A multi-language compiler framework can be used inside the language independent editor. The compiler framework can be used to perform the task of a normal command-line compiler, and can also provide the language information necessary for implementing editor features. Having a single compiler can reduce the amount of work needed to add a new language and to modify and extend that language. It can also ensure that the editor's compiler is of the highest quality.

In addition, the compiler framework can make it easy to turn language information into editor features. This can allow language designers to focus on their language and not have to worry about implementing the editor-side as well.

The tight integration of the compiler into the editor, along with the extra time made available by not having to implement a separate compiler for the editor, significantly improves the language-based features of an editor. Here are some examples of the improvements that a compiler framework can make possible:

Performance

The performance many command-line compilers is not good enough for use in an editor, where reparsing occurs each time the user pauses after typing. Therefore, editing a 2000 line file can be very cumbersome.

The compiler framework makes it possible to reparse in “near real-time” with no performance degradation noticeable to the user.

Error Display

In general, editors provide visual indication of errors in a single language. The compiler framework enables the editor to provide visual indication of errors throughout a source file with mixed languages. Furthermore, the compiler framework keeps track of errors in all source files in the project so that the user can have a complete list of every error in the source, even in unopened files, at all times.

Error Correction

Typical command-line compilers do a poor job of recovering from errors. Often a single error by the user will cause a hundred error messages to display. Poor error recovery also causes other features, like code completion, to be unavailable more often that necessary.

The compiler framework provides parsers that automatically include sophisticated error recovery. This should make most errors cause only a single error message, with the parser continuing as if the error had not occurred. This will make code completion much more robust, with failure a very rare event.

The compiler framework also has error correction in the code-generation of the compiler. This allows the user to run their code even if there are errors in it. Only if the user tries to execute a line for which correction was not possible will it fail.

Auto Correction

The compiler framework also makes it possible to provide the next level of help to users. Instead of just telling the user that there are errors in the code, it can offer to fix them. For example, if the user misspells a variable name, it can provide the user with a list of closely matching names. If the user references a class that is not imported but exists somewhere in the source, it can offer to add an import of the class. If the user forgets a semicolon, it can insert it for them.

These are only a few examples of the kinds of features a compiler framework can provide by tightly integrating into the editor. The compiler framework can make all of the information produced by the compiler available in real-time for the editor to use, making possible almost any conceivable editor feature.

Compiler Framework Services

The sections below describe what a compiler framework can do for various consumers of the compiler framework functionality, such as runtime, editor, or language designer consumers. Also included is an exemplary list of languages that can be supported.

Runtime

Produce Annotated .class Files

Pointed at a directory of source code, the compiler framework produces a set of .class files that will correctly implement the semantics described by the source files. Each .class file may additionally contain annotation information (metadata) that also affects runtime behavior. See “Languages” below for the set of supported file types.

Language Designers

Provide Compiler Tools

The framework includes tools to help with building compilers for specific languages. This includes a parser generator. It also includes a scanner generator as well.

Robust to Errors

The generated parsers are able to recover from the majority of user errors (particularly, the common ones). In particular, they are able to recover from all single token errors and also those that occur during code completion (typically, a missing identifier).

The scanners are able to recover sensibly from any error.

Support Language Nesting

The framework allows one language compiler to pass off processing of a section of the document to another language compiler. This language compiler will then get to scan, parse, and type check the contents. The parse tree produced by the inner compiler will be available to the outer compiler.

It is able to choose the language to nest based on type-checking information in the outer language.

It is able to allow either the inner or the outer language to determine where the span of the inner language content ends.

Expose Language Information

The framework allows languages to expose information about the contents of the document in order to enable editor features.

Easy

It is relative easy to expose existing compiler information in order to get editor features. In particular, it should take no more than a few minutes of work to get syntax coloring or bold matching chars from lexical information.

Encapsulates Syntax Details

The exposed information encapsulates the details of the syntax such that the syntax can be changed without breaking the editor features that consume the information.

Editor

Provide Project Information

For the project as a whole, the compiler framework provides the editor with the following information:
1. The names of all classes and packages defined in the source code or libraries.
2. The errors found in any of the source files.
   Up-To-Date

All of this information is kept up-to-date for all files in the project. Once the compiler framework is notified of the change to a file, this information should be updated very rapidly.

Provide File Information

For an individual file, the compiler framework provides the editor with the following information:
1. The signatures of the classes defined by the file.
2. The errors found in the file.
3. The stack of nested languages at any point in the file.
4. The information exposed by any of the languages.
   Up-To-Date

Once the compiler framework is notified of a change to the file, this information is updated within the time limits for a single-file recompile.

Provide File Information Changes

When the compiler framework is notified of a change to a previously compiled file, it recompiles the file and provides the editor with lists of the changes that occurred to the file information (see “Provide File Information” above).

Languages

Java initially supports the following languages:
Java and JavaScript The Java and script languages are directly supported. These include files of type java and js.
Controls A set of source code annotations and coding conventions that simplify interaction with external entities, such as web services. These annotations may be embedded in a variety of languages and are defined in control definition files.
JWS The Java for Web Services (JWS) language for implementing web services includes files of type .jws, .wsdl, and .xmimap. In addition, it includes support for web services written in script.
JSPX The JSPX language for implementing web UI includes files of type .jspx and.trd. Additionally, it includes support for web UI written in script.
WebFlow The webflow language for implementing the flow between pages of web UI includes files of type .jwf (will change). Additionally, it includes support for flow written in script.
WSPL The WSPL language for implementing business processes management includes files of type .jwf. Additionally, it includes support for processes written in script.

The framework can include direct support for Java with annotations, script with annotations, and XML with Schema. The JWS, JSPX, and WSPL are implemented by extending and nesting the basic languages that the framework provides.

The annotations/schema information can define which tags and attributes are allowed in the document. (In the annotation case, this information may change dynamically based on the Java/script content.) This information can be used to check the validity of the tags and attributes. This information can also include code to perform additional validity checking.

Example Editor Features Enabled Across Languages

With the rich set of information provided by the compiler framework, it is possible to create a large set of useful source editor features that make it a more powerful tool. Below are some examples.

Editing Features

The editor for an IDE should know something about the languages it can edit and as a result it can provide a number of useful features which make it easier to edit source files in that language.

Token Coloring

Modern editors provide support for displaying certain tokens, such as keywords, comments and strings, in special colors to help the user better understand the source code.

Comment Editing Help

When editing multiline comments, the editor can insert characters when the user starts a new line. For instance, in Java the user might type “/**” followed by pressing enter, and the editor should insert a “*” automatically, following the standard Java formatting rules for multiline comments (the auto-indenting should also come into play in this situation).

Auto-Indenting

When the user is typing certain syntactic constructs, the editor can help them by adding the appropriate indentation when enter is pressed or when certain keys are pressed. For instance, after the user types a “{” and presses enter, the editor can indent the next line by the given indent width. In addition, the editor may automatically indent a line correctly when tab is pressed anywhere on the line, or when the user types certain tokens such as “;”.

Matching Tokens

Certain tokens are naturally paired, such as “{” and “}” in Java or C++. The editor may allow the user to move the cursor from one member of a token pair to the other. In addition, it may use a visual indicator to show which tokens are paired either when the token is typed or when the cursor is adjacent to one of these tokens.

Edit by Token

When the user is moving the cursor, selecting text or deleting text, it is frequently useful to be able to do these actions based on token boundaries. For instance, a double-click can be used to select an entire token, control+left/right arrow can be used to move left or right a token at a time.

Code Information

There are many cases where type information can be used to provide the user with help understanding the meaning of identifiers or to help them understand what function calls and variable references are legal in a certain context.

Completion list

Whenever the user is editing their source code, they should be able to activate a feature which, based on the context in which they are editing, tells them possible text that may be inserted. There are a number of places where this feature could be used:
After the “.” on an object.
After the “.” on a package (in imports or elsewhere).
After the “new” keyword.
After the “<” on an XML start tag.
After the “</” on an XML end tag.
   Parameter Information

When the user is editing the argument list for a method call, the editor may show a list which displays the different legal argument signatures, including the types and argument names (if available). As the user edits the signature, this list displays which argument the user is editing and shows which signature are still legal based on the types of the arguments the user has already entered.

Identifier Information

When the user mouses over (or otherwise selects) an identifier, full information about that identifier can be shown. If it is a variable, the type of the variable can be shown and if it is a function the full signature can be shown. In addition, the user can be taken to the declaration of the member and cycle through the other uses of that member.

Browsing and Navigation

Class Browser

A class browser allows the user to find out what classes are defined in a project, what members and methods the classes contain and the inheritance relationships between the classes. In addition, the user can typically go to any definition or use of a class, member or method.

Navigation Bar

The navigation bar allows the user to see the classes, members and methods defined in the current file and navigate to the location in the file where these items are defined.

Error Detection & Correction

Squiggly Underlines

When the user enters code that contains an error or warnings, these can be detected without a compile and indicated in the source file (like the spelling error squiggly underlines in MS Word). They may be updated in real time as the user types and when the user selects one of these errors, they can see the full error message. In addition, a complete list of these errors for all files can be displayed in the IDE, so that the user never has to recompile the project when they just want an up-to-date list of their errors.

Error Auto-Correct

Certain types of errors such as leaving out an import or misspelling an identifier have obvious auto-correct candidates which can be determined by an IDE integrated compiler. When the user selects these errors, they can be presented with a list of possible correction options which can be automatically inserted into the source code.

Benefits

The benefits of the language independent editor are numerous. This section lists several examples of benefits that can be obtained using embodiments of the present invention.

Rapid New Language Support

Adding new languages to a development environment no longer requires the development of a new smart editor. Because the communication between the compiler framework and the source editor is language independent, new languages can be added without a single change to the editor. The compiler framework will provide a rich set of information about the syntax and semantics of each newly added language, immediately enabling a rich set of smart editor features. This drastically reduces the time and effort required to add a new language to a development environment.

Rapid New Editor Features

Similarly, decoupling the editor from the specific set of compilers means new editor features can be developed once, but will benefit all programming languages plugged into the compiler framework. It is not necessary to add the new feature to a separate editor for each language.

Consistent Editing Experience

Because there can be a single implementation for all editor features applied to all languages in the compiler framework, the editor can perform uniformly and consistently no matter what language is being edited. Consequently, users who have become accustomed to certain features in one language can use them in another language. The keystrokes and other gestures required to activate and use those features will be the same. The behavior of the editor will be familiar and unsurprising even if the developer is editing a new an unfamiliar language.

Language Nesting

Because an editor can be language neutral, it can support arbitrarily nested languages. An underlying compiler framework can consult different language modules for each nested portion of the source code and provides information about the syntax and semantics in a language neutral form. The compiler framework can also inform the editor where each language begins and ends within a source file so the editor can apply different user preferences for each language (e.g., the user might like different syntax coloring schemes for different languages).

One of the benefits of such architecture is that a new language compiler and a new language editor do not have to be developed for each new combination of nested languages. For example, if the compiler framework already has an XML language module and an ECMAScript language module, nesting XML within ECMAScript requires relatively minor modifications to the ECMAScript language module. It is not necessary to create a new language module to enable this functionality and no modifications to the editor are required.

Common Sub-Languages

The language independent editor can reduce the time and cost of embedding common sub-languages within several host languages. The sub-language can be developed once as an independent language module and nested inside as many other languages as needed. Detailed information about the syntax and semantics of the sub-language need not be added separately to each host language.

In addition, an editor may not need to know the information provided by the compiler framework about the sub-language is derived from a different language module. Therefore, the sub-language can be added to an arbitrary number of host languages without requiring any modifications to the Editor.

Changes to the sub-language can be made in place and will be reflected in all host languages. The user experience working with these sub-languages will be consistent regardless of the host language in which they are embedded. All editor features, including syntax coloring, error reporting and statement completion will be uniform and familiar.

Customized Language Features

APIs exposed by a language independent editor can allow custom language features to be developed easily and quickly. An API can provide default implementations for all the built-in editor features, and can allow extensions to modify or replace existing features or add completely new features. This extensibility can be very useful when the editor does not provide all the desired features or for unusual languages where the existing features need to be customized.

Customized Views

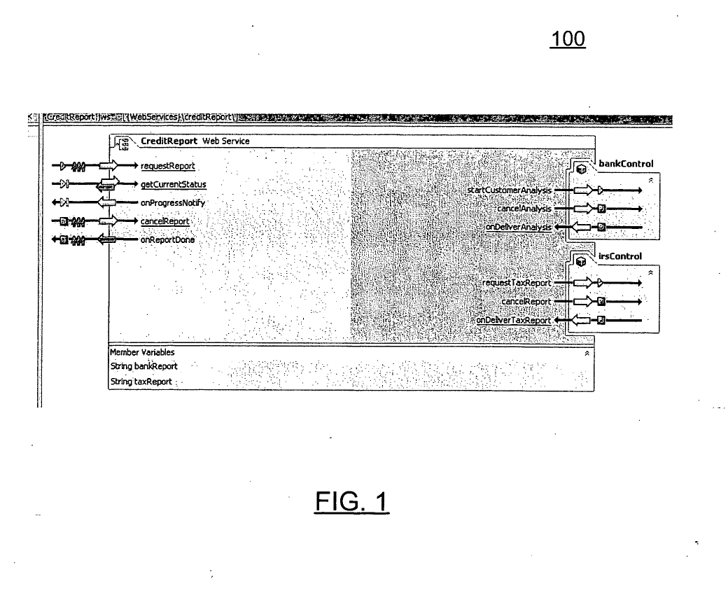

A language independent editor can also expose APIs that allow third parties to add custom, language editing views to the editor. For example, a workflow programming language might provide a graphical editor for business processes that allows users to create and modify the business processes by dragging and dropping icons on the display. The underlying source code would be modified simultaneously and source code changes could be viewed in a second window while they occur. Alternately, a web service editor might provide a view for graphically understanding and manipulating how the web service interacts with clients and external entities (e.g., other web services). Error! Reference source not found. FIG. 1 shows an example of a visual web service editor.

Data Driven Editor

As discussed earlier, the features of the language independent editor can be driven by language independent data provided by the compiler framework. This section describes examples of some of the key pieces of information provided by the compiler framework. A complete description of the API that governs the interaction between the compiler and editor is described elsewhere herein.

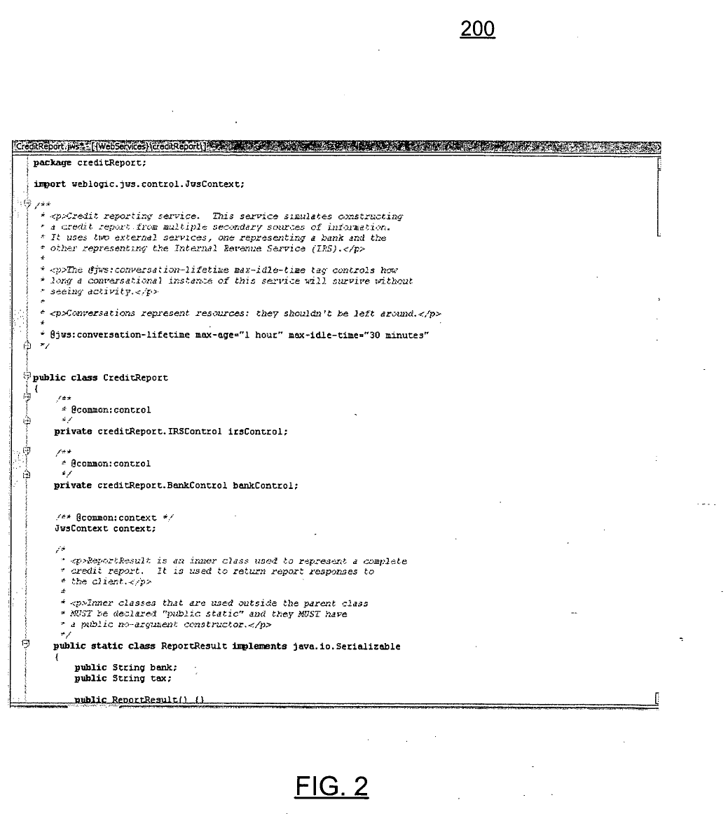

One of the important pieces of information that can be provided by a compiler framework is a stream of token nodes. Each token node can identify the start, end and type of a particular token identified by the compiler. The editor can use this information to provide features such as syntax coloring. For example, Error! Reference source not found. FIG. 2 shows a source file highlighting keywords, identifiers, comments, annotations, attributes and attribute values using different color schemes.

Another important piece of information that can be provided by the compiler framework is a tree of language nodes representing the nested languages in the file. The compiler framework can determine the first language used in a source file by its file extension (e.g., .java, .jws, .jsp, etc.). The host language, based on its syntax, can identify subsequent languages. For example, the JSP language uses the delimiters <% and %> to identify nested sections of Java code. Each language node identifies where the nested language section starts and ends. In addition, it can identify the name of the language (e.g., via com.bea.compiler.lLanguage) and any additional nested language sections inside of it (via a getChildren( ) method). A compiler can use this feature to e.g. allow users to specify different editor preferences for different languages.

A compiler framework can also provide information about the entire project, individual files, text buffers, errors in the code, changes to the code and more.

Principal Compiler Framework Components

Below are descriptions of the principal components of a compiler framework in accordance with one embodiment of the present invention.

Project Compiler

The Project Compiler contains the list of source directories and the class path. However, the principal data structure maintained by the project compiler is the type cache (part of the java type namespace).

The type cache contains Java signatures for all of the classes that exist in the project. Some of those classes come from class files on the class path and the others come from files in one of the source directories. One of the most important jobs of the compiler in the IDE setting is to keep the type cache up to date by watching for changes in the files in the source directories. This task is performed by one of the worker threads in the thread pool (see below).

The type cache is indexed by file name and by class name. For each file, the entry contains the current list of errors. This means that at any time the IDE can know which files contain errors and can display those errors without opening the file. For each class, the type cache maintains a list of dependencies. A reverse index of dependencies also exists so that the compiler can quickly determine if changes made have broken dependencies in unchanged files.

Another important benefit of the type cache is improving the performance of type checking. The type cache allows a single file to be compiled without processing any other files. All external information needed to compile the file is contained in the type cache.

The project compiler (and its contained type cache) is serializable. The IDE will serialize the final state of the compiler to disk when the IDE is closed so that it can display the available classes when the IDE is reopened without parsing any files (other than those changed since closing).

File Compiler

A file compiler can be used to perform compilation of a single source file. It is designed to perform incremental compilation. Hence, it can maintain data structures containing the result of the previous scan, parse, and, in the case of a non-Java language, translation into Java classes. When changes are made to the file in memory, the next compile can reuse much of the previous results, vastly speeding up the process.

One of the unique features of this compiler is its built-in support for nesting of languages. The compiler maintains data structures containing information about where language nesting occurs (according to the last parse of the file). This is critical for the editor, which must react differently depending on which language contains the cursor at any given moment.

The compiler can support the interoperation of different languages. Specifically, any language can call into any other language. This is accomplished by using a common intermediate language. Since the target platform is the Java VM, the clear choice for intermediate language is Java itself. The compiler has a common Java back-end, which is used by all languages for producing byte codes. Each language is able to translate from its parse tree into Java classes. These classes are placed into the type cache to allow other languages to reference them.

Also important is the framework for language nesting. The outer language is able to determine where the inner language begins. Either the inner or the outer language may determine where the inner language ends. (In the normal case, the outer language will determine this. However, in special cases, the inner language can as well.) The file compiler will remember where the language nesting occurred for reuse on the next parse. Lastly, the outer language may implement a name resolution interface to allow the inner language to resolve references to names defined outside of the nested language.

Thread Pool

A thread pool can be used in both the IDE and runtime. In the context of the IDE, all parsing needs to be performed on background threads so that the process may be interrupted (if the user starts typing, for example). In the context of the runtime, the thread pool allows compilation of multiple files to be performed in parallel. Compilation should scale linearly to the number of processors. Naturally, all compiler data structures are implemented with appropriate synchronization. They do not assume that the client is accessing the APIs in a single-threaded manner.

Languages

Language objects can provide the editor with information needed to implement editor features. Language objects contain a method for retrieving different types of information using keys. If that language provides the information, the result of the lookup will be an object implementing a known interface. If not, the result will be null.

Standard interfaces exist for the type of information needed to implement standard editor features. Features that only exist for one language are implemented with custom interfaces. Standard interfaces also have default (abstract) implementations. Language implementers that want to provide such information only need to implement the abstract methods of the default implementation.

As an example, one standard interface provides information about matching characters in the token stream. This may be used to implement several features in the editor, such as the bolding of matching characters and the move to matching character keyboard command. To provide this information for a particular language, the language implementer only needs to implement methods describing which tokens match with which other tokens. The code that performs the search will be provided in the default base class.

These interfaces do not represent editor features directly. Rather they will represent types of information that is used to implement editor features. The code for turning this information into real features will exist in the editor.

As described above, data structures in the file compiler allow the editor to retrieve the stack of languages in affect a given point in the code. Maintaining languages as objects that can be retrieved in this manner is important because it provides that the same language features are available no matter where that language is used. For example, XML end tag completion should be available whether the user is editing a WSDL file, an XML map nested inside of an annotation in a JWS file, or XML in a script file. This will occur because all situations return the same language object for the XML part of the source.

Compiler Framework Interaction

When a new file is added to the project or an existing file is modified, the editor can notify the compiler of the change (e.g., via the interface com.bea.compiler.IProject). The compiler framework and the editor can both have access to the text buffer containing the contents of the file being edited. Each time the user modifies the file, the following exemplary steps can be taken.

1. The user types a character (or otherwise modifies the file)

2. The editor sends a change notification to the compiler framework identifying the changed file, changed text and the type of change (see the interfaces com.bea.compiler.IFileChange and com.bea.compiler.ITextChange)

3. The compiler framework reads and retokenizes the source updating the Token and Node information

4. The compiler framework then enqueues a task for itself to complete the rest of the compilation in a background thread so the user gets immediate feedback and does not detect any visible delay in typing responsiveness while the compiler finishes processing the change.

5. The editor then repaints the screen giving immediate feedback to the user and showing the syntax coloring associated with the new tokenization.

6. Every 250 milliseconds or so, the compiler framework empties the tasks it has enqueued for itself and completes the remaining steps in the background.

7. The compiler framework compiles the changed file(s) in the background. [Note, a change to one file might actually result in several files being recompiled and e.g., new errors being generated for those files. The compiler maintains a type cache that represents dependencies between files enabling it to determine which files must be recompiled based on a given change.]

8. The compiler framework notifies the editor and IDE of changes indicating which files have changed e.g. using the method com.bea.ide.sourceeditor.DefaultSourceDocument.mergeMetadata( ).

9. The editor reexamines those files and merges the changes with its own internal representation of the parse tree (see section 0). It generates change notifications for each item it identifies that has changed.

10. The editor repaints the screen showing visual representations of the parsing results. For example, newly introduced errors may be highlighted using squiggly red underlines. If the code structure has changed, the change may be reflected in the structure browser.

It is important to note that the compiler may only complete a small amount of work needed to give immediate feedback to the user while the user is typing. All the larger tasks can be staged for background computation, so as not to disrupt responsiveness to the user.

Parse Tree Merge Algorithm

To maintain a positive user experience, it can be important for the merge algorithm mentioned above to be very efficient and to identify the minimal number of changes required to synchronize the parse trees maintained by the editor and the compiler framework. Each change notification generated by this algorithm may result in a significant amount of additional work, which could slow the system down. Therefore, naive comparison algorithms that tend to “get lost” and generate false positives for portions of the file that have not actually changed may not suffice.

One merge algorithm with acceptable characteristics is presented below. The algorithm is recursive and is initially called passing the root nodes of the destination parse tree and source parse tree as parameters. The trees are constructed of nodes with edges connecting each parent node to its child nodes. Each destination node has a set of properties, which must be updated based on the associated source node.

MergeParseTrees(destinationNode, sourceNode)

| | |
|---|---|
| 1. | For each propery p on the destinationNode, set the value of p to the value of the |
| | property of the sourceNode with the same name as p. |
| 2. | Let numDestinationChildren = the number of child nodes of destinationNode |
| 3. | Let numSourceChildren = the number of child nodes of sourceNode |
| 4. | Let maxComparisons = minimum(numDestinationChildren, numSourceChildren) |
| 5. | // compare children left to right merging them until a match is not found |
| 6. | Let lastLeftMatch = −1 |
| 7. | Let childEqual = true |
| 8. | Let i = 0 |
| 9. | while (i < maxComparisons and childEqual== true) |

| | |
|---|---|
| a. | Set childEqual to true if destinationNode.child(i) is equal to |
| | sourceNode.child(i) (i.e., they refer to the same item in the document)) |
| b. | Otherwise set childEqual to false. |
| c. | If childEqual == true |

| | |
|---|---|
| i. | MergeParseTrees(destinationNode.child(i), sourceNode.child(i)) |
| ii. | lastLeftMatch = i |

| | |
|---|---|
| d. | i = i + 1 |

| | |
|---|---|
| 10. | // if all children have been compared equal, return |
| 11. | if (numDestinationChildren == numSourceChildren) and (lastLeftMatch == |
| | numSourceChildren-1) |

| | |
|---|---|
| a. | return |

| | |
|---|---|
| 12. | // compare children right to left merging them until a match is not found |
| 13. | Let lastRightMatch = maxComparisons |
| 14. | childEqual = true |
| 15. | i = maxComparisons − 1 |
| 16. | while (i > lastLeftMatch and childEqual == true) |

| | |
|---|---|
| a. | Set childEqual to true if destinationNode.child(i) is equal to |
| | sourceNode.child(i) (i.e., they refer to the same item in the document)) |
| b. | Otherwise set childEqual to false. |
| c. | If childEqual == true |

| | |
|---|---|
| i. | MergeParseTrees(destinationNode.child(i), sourceNode.child(i)) |
| ii. | lastRightMatch = i |

| | |
|---|---|
| d. | i = i − 1 |

| | |
|---|---|
| 17. | Let gap = lastRightMatch − lastLeftMatch − 1 |
| 18. | Let sourceGap = numSourceChildren − maxComparisons + gap |
| 19. | Let destinationGap = numDestinationChildren − maxComparisons + gap |
| 20. | // remove deleted nodes |
| 21. | if (sourceGap == 0 and destination Gap > 0) |

| | |
|---|---|
| a. | for j = 0 to destinationGap |

| | |
|---|---|
| i. | destinationNode.removeChild(lastLeftMatch + 1) |

| | |
|---|---|
| 22. | // add inserted nodes |
| 23. | else if (sourceGap > 0 and destinationGap == 0) |

| | |
|---|---|
| a. | for j = 0 to sourceGap |

| | |
|---|---|
| i. | Let child = sourceNode.child(lastLeftMatch + j + 1) |
| ii. | destinationNode.insertChild(lastLeftMatch + j + 1, child) |

| | |
|---|---|
| 24. | // same number of nodes in gap. Replace or merge |
| 25. | else if (sourceGap == destinationGap) |

| | |
|---|---|
| a. | for j = 0 to destinationGap |

| | |
|---|---|
| i. | Let sourceChild = sourceNode.child(j + lastLeftMatch + 1) |
| ii. | Let destChild = destinationNode.child(j + lastLeftMatch + 1) |
| iii. | If sourceChild and destChild are the same type of node, |
| | MergeParseTrees(destchild, sourceChild) |
| iv. | Otherwise, replace destChild with sourceChild in sourceNode |

| | |
|---|---|
| 26. | // different number of nodes in gap. Remove and Insert |
| 27. | else |

| | |
|---|---|
| a. | for j = destinationGap-1 downto 0 |

| | |
|---|---|
| i. | destinationNode.removeChild(lastLeftMatch + j + 1) |

| | |
|---|---|
| b. | for j = 0 to sourceGap |

| | |
|---|---|
| i. | Let child = sourceNode.child(lastLeftMatch + j + 1) |
| ii. | destinationNode.insertChild(lastLeftMatch + j + 1, child) |

| | |
|---|---|
| 28. | return |

Language Nesting

Because an editor can be language independent, nested languages can be handled. All detailed knowledge about the various languages can be embedded in language modules plugged into the underlying compiler framework. A compiler framework can use language neutral APIs described elsewhere herein to communicate understanding of the language concepts to the editor (e.g., positions and types of tokens, errors, etc.).

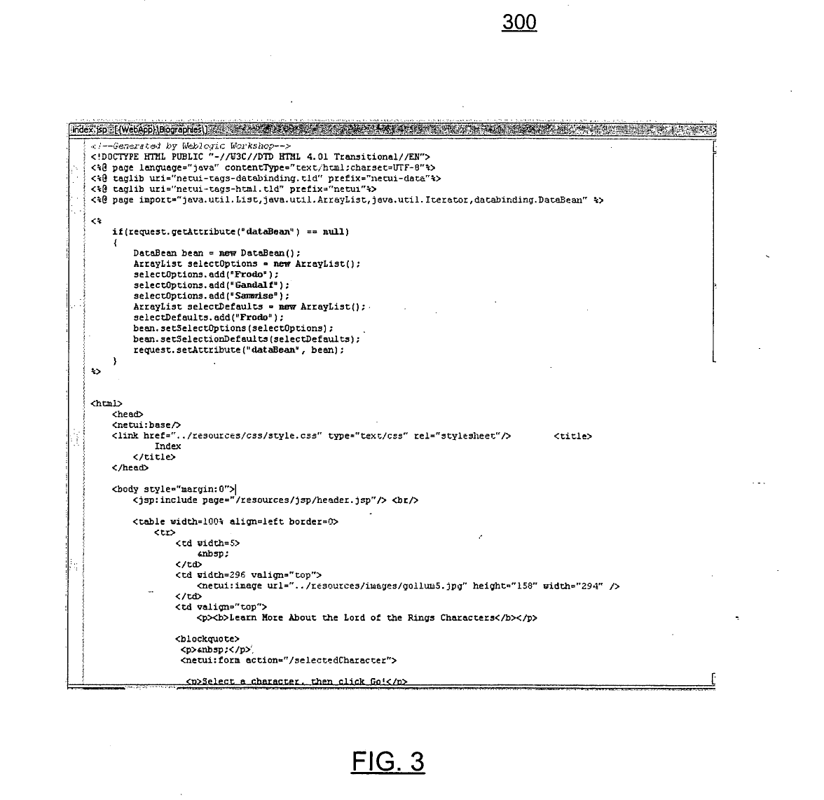

The editor can use the information provided by the compiler framework to determine which language is currently being edited and detect when the user moves the cursor from one language to another. This is useful e.g. if the user wants to establish different editing or display preferences for each language. For example, FIG. 3 shows how different syntax coloring schemes might be applied for the Java, HTML and JSP tag languages in a JSP file.

The compiler can expose information about the languages used in a source file as a tree of language nodes. Each language node can identify a section of the file written in a particular language. The start position, stop position and information about the language (e.g., its name) are provided. If necessary, the editor can navigate this tree to understand all the languages used in a given source file and how they are nested inside one another.

The compiler framework can determine the initial language of each file using the file type (e.g., determined by a filename extension). It can then pass the file to language module that is registered to process files of that type. The language module in turn is programmed to identify the type and start position of any nested languages allowed in that language. The language module may also identify the end position of the nested language, but may request the assistance of the nested language processor for this task. Once the type and boundaries of a nested language are identified, the compiler framework will pass this portion of the file to the language module registered to process that language type. This process may continue allowing the editor and compiler framework to handle arbitrarily deeply nested languages.

Language Drivers

If the developer of a language module or custom language editing view wants to expose unique editing features tailored toward a specific language, they can implement a language driver. The language driver encapsulates the unique characteristics of the language and allows them to be plugged directly into the editor without requiring language specific features to be added to the editor itself. The complete API for developing language drivers is described in detail elsewhere herein.

Custom Editors and Views

Developers that wish to build custom editors for specific languages may do so by creating a class that implements the ISourceDocument interface specified elsewhere herein. The class DefaultSourceDocument can provide a default implementation of all the relevant editor features. Developers may derive their implementation from this class so they only have to override the specific behaviors they want to customize.

Likewise, developers wishing to build custom views for a specific language may do so by creating a class that implements the ISourceView interface specified also specified elsewhere herein. The class DefaultSourceView can provide a default implementation of all relevant view features. Developers may derive their implementation of ISourceView from this class so they only have to override the specific behaviors they want to customize.

Application Interfaces

Editor Extension API

A language independent editor can expose a set of APIs that can be used to define custom editor features and custom views for specific languages (e.g., visual editing tools). The full details of this API are described in this section.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

The foregoing description of preferred embodiments of the present invention has been provided for the purposes of illustration and description. It is not intended to be exhaustive or to limit the invention to the precise forms disclosed. Many modifications and variations will be apparent to one of ordinary skill in the art. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

1. A system for providing the ability to edit source code, comprising:
means for providing an extensible multi-language capable compiler framework; and
means for embedding the framework in a language-independent source code editor, such that the compiler framework can provide the editor with information about a language to be edited.

2. A computer-readable medium, comprising:
means for providing an extensible multi-language capable compiler framework; and
means for embedding the framework in a language-independent source code editor, such that the compiler framework can provide the editor with information about a language to be edited.

3. A computer program product for execution by a server computer for providing the ability to edit source code, comprising:
computer code for providing an extensible multi-language capable compiler framework; and
computer code for embedding the framework in a language-independent source code editor, such that the compiler framework can provide the editor with information about a language to be edited.

4. A computer system comprising: a processor;
object code executed by said processor, said object code configured to:
provide an extensible multi-language capable compiler framework; and
embed the framework in a language-independent source code editor, such that the compiler framework can provide the editor with information about a language to be edited.

5. A computer data signal embodied in a transmission medium, comprising:
a code segment including instructions to provide an extensible multi-language capable compiler framework; and
a code segment including instructions to embed the framework in a language-independent source code editor, such that the compiler framework can provide the editor with information about a language to be edited.
